(19) United States
(12) Patent Application Publication
(10) Pub. No.: US 2008/0067120 A1
(43) Pub. Date: Mar. 20, 2008

(54) System and method for dispensing a filtered liquid

(76) Inventor: Mon Chatrath, Portland, OR (US)

Correspondence Address: LAHIVE & COCKFIELD, LLP, ONE POST OFFICE SQUARE, BOSTON, MA, 02109-2127, US

(21) Appl. No.: 11/804,497

(22) Filed: May 18, 2007

Related U.S. Application Data
(60) Provisional application No. 60/812,332, filed on Jun. 9, 2006.
(60) Provisional application No. 60/815,350, filed on Jun. 21, 2006.

(51) Int. Cl. B01D 35/00; B01D 35/28; B65D 41/04

(52) U.S. Cl. 210/435; 210/455; 220/361

(57) ABSTRACT

A liquid filtration and dispensing system stores a liquid, such as water or another beverage, filters the liquid with an integrated component, and dispenses the filtered liquid for use, such as for drinking. The liquid filtration and dispensing system includes a dispenser body for storing a liquid or fluid to be filtered and/or dispensed from the system. A filtration assembly, also known as a “cartridge”, couples to the dispenser body, and includes a filtration mechanism, or space for inserting a filtration mechanism, for filtering liquid stored in and/or expelled from the dispenser body. The filtration assembly may be removable and replaceable once spent. A dispenser capping element couples to the filtration assembly to seal and contain the filtration assembly, and includes a discharge opening for dispensing a filtered liquid from the system. The filtration assembly may also include an air vent assembly to facilitate dispensing of the liquid.

### RELATED APPLICATIONS

The present invention claims priority to U.S. Provisional Application No. 60/815350, filed Jun. 21, 2006 and entitled SYSTEM AND METHOD FOR DISPENSING A FILTERED LIQUID, as well as U.S. Provisional Application No. 60/812332, filed Jun. 9, 2006 and entitled SYSTEM AND METHOD FOR DISPENSING A FILTERED LIQUID, the contents of which are herein incorporated by reference.

### FIELD OF THE INVENTION

The present invention relates to filtration of liquids and, more specifically, to methods and systems for storing and dispensing a filtered liquid.

### BACKGROUND OF THE INVENTION

The quality of the drinking water has been compromised in many parts of the world as the sources of water pollution in our industrial age have increased. The presence of both organic pollutants, such as bacteria and viruses, and inorganic pollutants, such as heavy metal, in drinking water remains a great concern.

To make matters worse, increases in industrial output and population have resulted in an increase of water consumption. Consequently, portable and clean water has become a valuable commodity.

It is not surprising then, that the volume of the bottled water sold has increased as people have become distrustful of public sources of water. However, in some instances, the purity of the bottled water may be questionable if the sources of such water have been compromised with industrial waste. For at least these reasons, cost effective methods and systems that can provide cleaner water are desirable to help address this undesirable problem with portable water quality.

### SUMMARY OF THE INVENTION

The present invention provides an improved system and method for the efficient purification and dispensing of drinking liquids stored in a dispenser. The liquid dispenser described herein includes what is commonly referred to as a “water bottle” or “bottled water,” although it should be understood that the principal of the present invention can be applied to other liquids for which purification may be desirable, including drinks and containers holding other drinkable liquids, such as juices, sodas, milk, coffee, tea, and alcoholic beverages. Additionally, those skilled in the art will appreciate that the term “bottle” or “dispenser” can include any container from which a liquid can be dispensed for drinking or for other uses, such as cleaning.

The dispensers in one embodiment of the present invention are supplied with devices, such as filters and decontamination materials that can remove or deactivate impurities and micro-organisms in a liquid stored therein prior to dispensing the liquid from the dispenser.

In one embodiment of the invention, hollow fiber can be used as a filtering medium for the dispenser. Hollow fiber UF membrane technology for treating water provides an effective way to both clarify and disinfect water. The hollow fiber membrane, which resembles strands of membrane, which resemble strands of spaghetti that are hollow inside, utilize physical exclusion to filter water. The polymeric walls of the membrane strand have billions of pores that act as a strainer to filter out particles, turbidity, and pathogens while allowing water to flow through with virtually no pressure drop. Hollow fiber generally operates under very low pressure. Hollow fiber membranes effectiveness and performance may be based on pore size, distribution, permeability, surface area and fouling characteristics of the membrane

Alternatively, the filter medium for the dispenser of the present invention comprises a filters and decontamination material that can remove or deactivate impurities and micro-organisms. For example, activated carbon may also or alternatively be used as a filtering medium. Activated carbon can be used to eliminate undesirable odors and taste as well as many organic compounds, residual chlorine and potentially hazardous elements, such as pesticide and herbicide. The activated carbon acts like a sponge attracting and retaining chemicals as the water passes through

Other suitable filter media include, but are not limited to: sediment, ceramic and other materials known in the art.

According to one aspect of the invention dispenser for dispensing a liquid comprises a dispenser body including a liquid chamber for storing a liquid, and a filtration assembly removably connected to the dispenser body for receiving a filter element for filtering said liquid. The filtration assembly includes an opening for releasing filtered liquid from the dispenser.

According to another aspect of the invention, a filtration assembly configured to cap a liquid dispenser body is provided. The filtration assembly includes a substantially tubular filtration housing, a flanged, disc-shaped filtration seat disposed within and coupled to the filtration housing to form a filter chamber for receiving a filter element therein, the filtration seat defining a seat for seating the filter element, and a top cap coupled to the filtration housing for covering the filtering chamber. The top cap including an opening formed therein for releasing a filtered liquid from the filter chamber. The filtration housing includes a coupling mechanism for coupling the filtration assembly to a liquid dispenser body.

According to still another aspect, a filter cartridge for a liquid dispenser comprises a filtration housing, a filter disposed in the filtration housing and a coupling mechanism for releasably coupling the filter cartridge to the liquid dispenser.

### BRIEF DESCRIPTION OF THE FIGURES

FIG. 1 is a cross-sectional view of a liquid filtration and dispensing system according to an illustrative embodiment of the invention.

FIG. 2 is a detailed cross-sectional view of section A of the liquid filtration and dispensing system of FIG. 1.

FIG. 3 is a detailed cross-sectional view of section B of the liquid filtration and dispensing system of FIG. 1.

FIG. 4 is a detailed cross-sectional view of section C of the liquid filtration and dispensing system of FIG. 1.

FIG. 5 is a detailed cross-sectional view of a filtration assembly suitable for use in the liquid filtration and dispensing system of FIG. 1.

FIG. 6A is a cross-sectional view of a filter seat element of the filtration assembly, suitable for seating a filtration device.

FIG. 6B is a top view of the filter seat element of FIG. 6A.

FIG. 7A is a cross-sectional view of a top filter capping element for the filtration assembly of FIG. 5.

FIG. 7B is a top view of the top filter capping element of FIG. 7A.

FIGS. 8A-8C illustrate a top dispenser capping element for the liquid filtration and dispensing system of FIG. 1.

FIG. 9 illustrates a filtration element suitable for use in the liquid filtration and dispensing system of an illustrative embodiment of the invention.

FIG. 10 is a cross-sectional view of a valve component suitable for use in the illustrative embodiment of the invention.

FIGS. 11A and 11B illustrate a dust cap suitable for use in the illustrative embodiment of the invention.

FIGS. 12A-12C illustrate a dispenser body suitable for storing liquid to be filtered and dispensed from the liquid filtration and dispensing system of FIG. 1.

FIGS. 13A-13D are illustrate coatings suitable for use with a dispenser body of an illustrative embodiment of the invention.

FIG. 14 is a detailed view of a filtration assembly of a liquid filtration and dispensing system of another embodiment of the invention.

FIG. 15 is a detailed view of a filtration assembly of a liquid filtration and dispensing system of another embodiment of the invention.

FIGS. 16A-16C illustrate a valve component of the system of FIG. 15.

FIGS. 17A-17B illustrate a top holder of the system of FIG. 15.

FIGS. 18A-18B illustrate an elastic rubber of the system of FIG. 15.

FIG. 19 illustrates a dispenser capping element of the system of FIG. 15.

FIG. 20 illustrates a filter seat of a liquid filtration and dispensing system of another embodiment of the invention.

FIG. 21 is a detailed view of a filtration assembly of a liquid filtration and dispensing system of another embodiment of the invention.

FIG. 22 is an exploded view of the system of FIG. 21.

FIGS. 23A-23B illustrate a filter seat of the system of FIG. 21.

FIGS. 24A-24B illustrate a filtration housing of the system of FIG. 21.

### DETAILED DESCRIPTION OF THE INVENTION

The present invention provides a system and method for storing, transporting, filtering and/or dispensing a liquid, such as a beverage. The invention will be described below relative to certain illustrative embodiments. Those skilled in the art will appreciate that the present invention may be implemented in a number of different applications and embodiments and is not specifically limited in its application to the particular embodiments depicted herein.

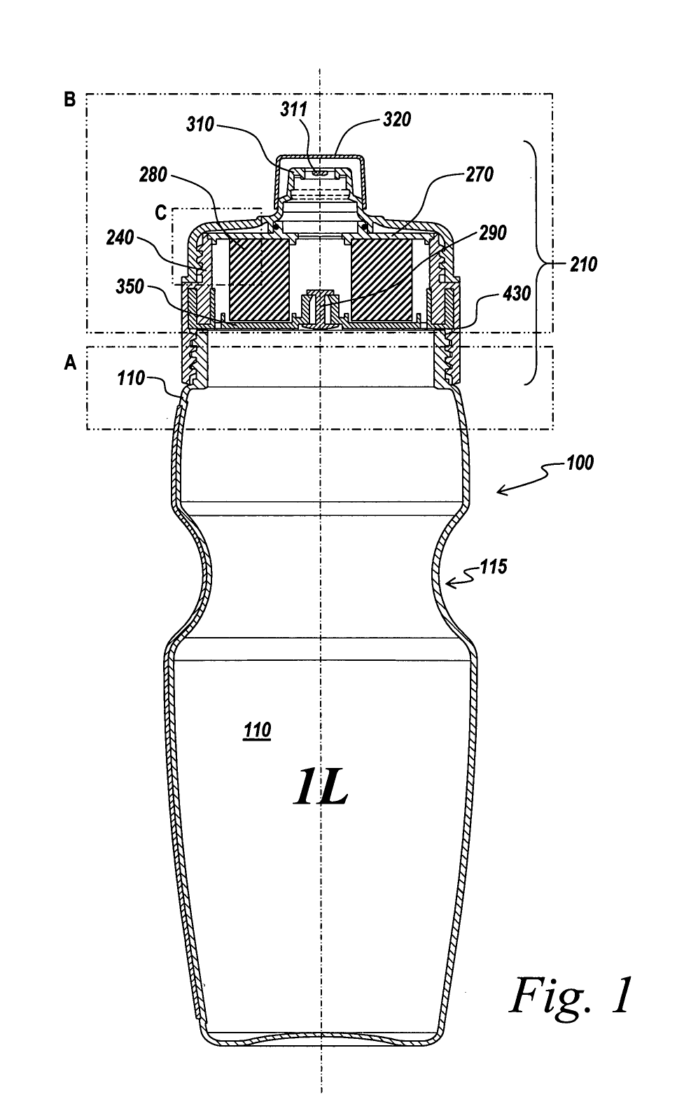

Referring to FIG. 1, a liquid filtration and dispensing system 100 stores a liquid, such as water or another beverage, filters the liquid with an integrated component, and dispenses the filtered liquid for use, such as for drinking. The liquid filtration and dispensing system 100 includes a dispenser body 110 for storing a liquid or fluid to be filtered and/or dispensed from the system. A filtration assembly 210, also known as a “cartridge”, couples to the dispenser body 110, and includes a filtration mechanism 280, or space for inserting a filtration mechanism, for filtering liquid stored in and/or expelled from the dispenser body 110, as described in detail below. The filtration assembly may be removable and replaceable once spent. A dispenser capping element 310 couples to the filtration assembly 210 to seal and contain the filtration assembly 210, and includes a discharge opening 311 for dispensing a filtered liquid from the system 100. The filtration assembly 210 may also include an air vent assembly 290 to facilitate dispensing of the liquid, as described below.

In one embodiment of the invention, the dispenser body 100 is squeezable to allow liquid to be forced therefrom. In addition, the composition of the dispenser body is preferably sufficiently inert so that undesirable chemicals or particles are not transferred from the body 110 to the liquid stored therein. The volume of liquid that can be contained in the dispenser body may be sufficient to quench thirst in many circumstances. The weight of the filled dispenser is preferably for a person to carry. The shape of the dispenser body 110 is such that it can be held and squeezed by hand. For example, the dispenser body may include a grip region 115 of reduced diameter to facilitate gripping and squeezing of the dispenser body 110. The shape and polymer material used in the construction of the dispenser body 110 preferably provide enough elasticity to allow the dispenser body to attain its original shape by creating a negative pressure to allow atmospheric air to enter after squeezing liquid out via the discharge opening 311.

When a user applies pressure and squeezes the dispenser body 110, the liquid passes through the filtration assembly 210 and purified liquid comes out of the top of the dispenser capping element 310. The filtered liquid may then be consumed by the user, or used for another suitable purpose. The filtration assembly 210 may also act as a dampener for water pressure and a distributor for an even supply of liquid to the filter element 280.

The dispenser body maybe formed from any appropriate material such as a polymer material, which is flexible enough to allow people of various strengths to squeeze the dispenser body to force liquid out for drinking or for another purpose.

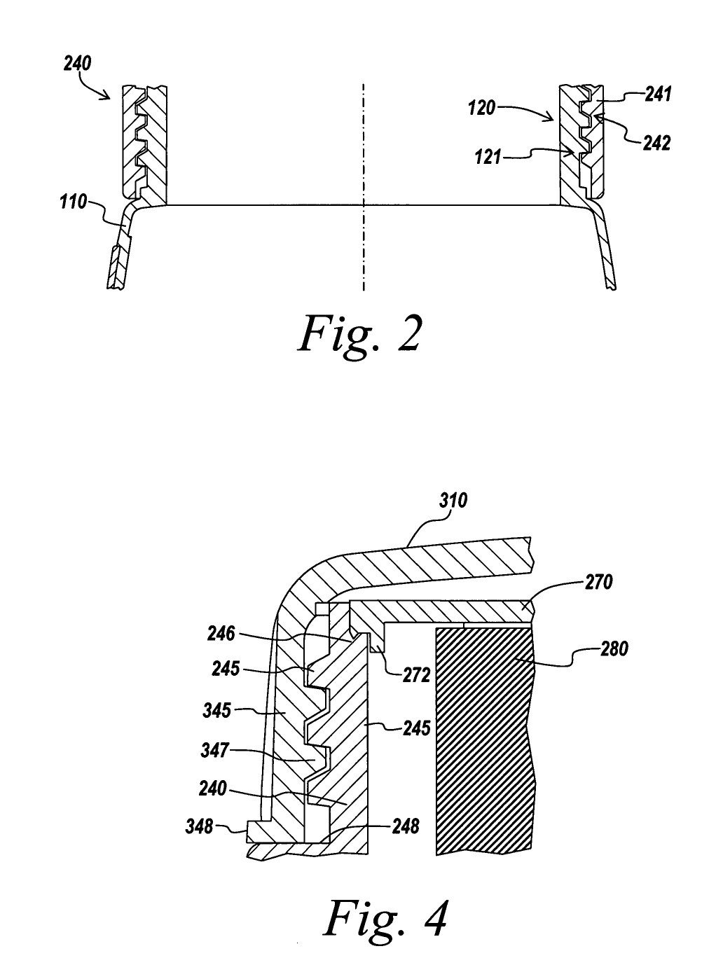

As shown in FIG. 2, the filtration assembly 210 may be mounted over the top opening of the dispenser body 110 to integrate a filtration process into the dispenser. In an illustrative embodiment, a top flange 120 of the dispenser body 110 may include external threads 121 or other suitable coupling mechanism. A bottom flange 241 of the filtration assembly 210 may include internal threads 242 configured to mate with the threads 121. In this manner, the filtration assembly 210 may be screwed onto the top of the dispenser body 110 to provide filtration of a liquid stored in the dispenser body 110. One skilled in the art will recognize that any suitable coupling mechanism, including friction fit, screws, snap-fit, other thread configurations, and other means known in the art, may be used to couple the dispenser body to the filtration assembly, and that the invention is not limited to the illustrative threads.

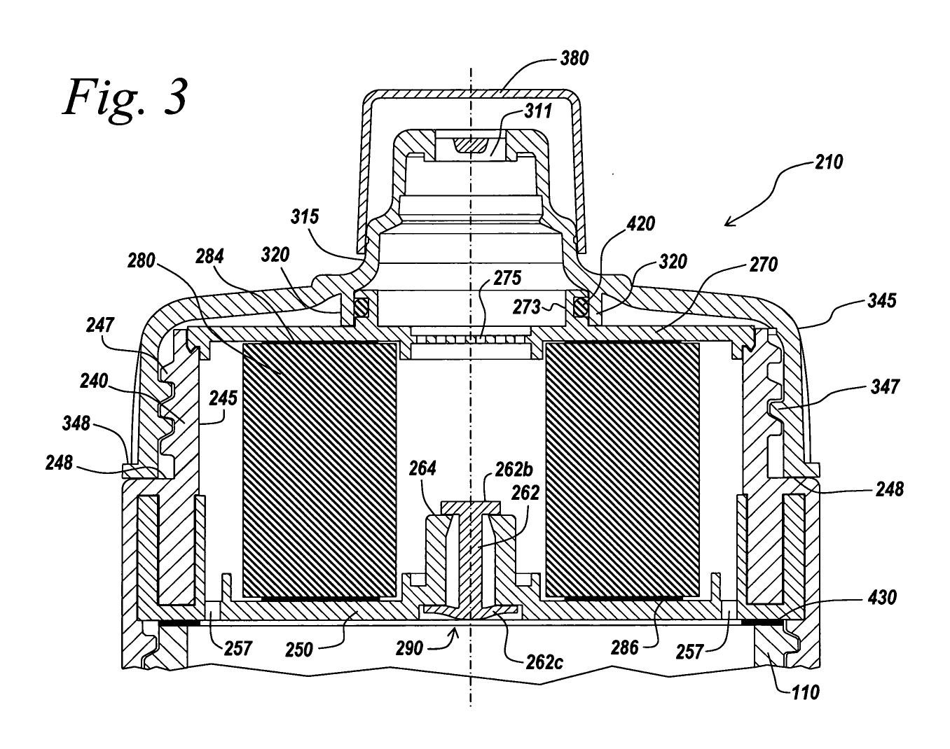

FIGS. 3-8C illustrate details of the filtration assembly 210 of an illustrative embodiment of the invention. As shown, the filtration assembly includes a substantially tubular filtration assembly housing 240 forming the threaded flange 241 described above. A filtration seat 250, having a substantially flanged, disc shape as shown in detail in 6A-6B, couples to the filtration assembly housing 240 directly above the flange 241 to define bottom of a filtration chamber 251 for filtering liquids. The filtration seat 250 may also define a seat for holding and retaining a filtration element, as described below. A filtration capping element 270 couples to a top flange 245 of the filtration assembly housing 240 form a ceiling for the filtration chamber 251.

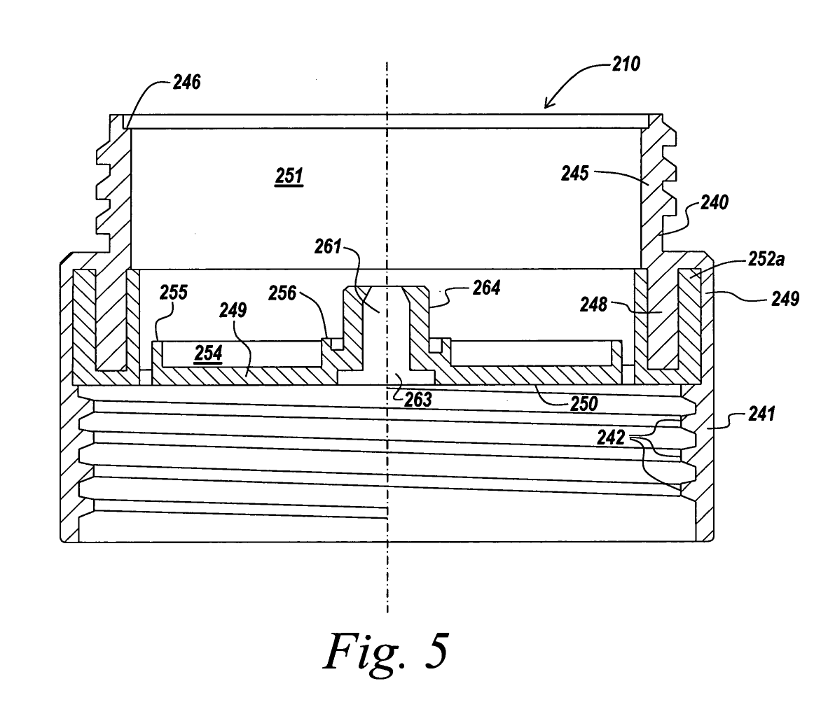

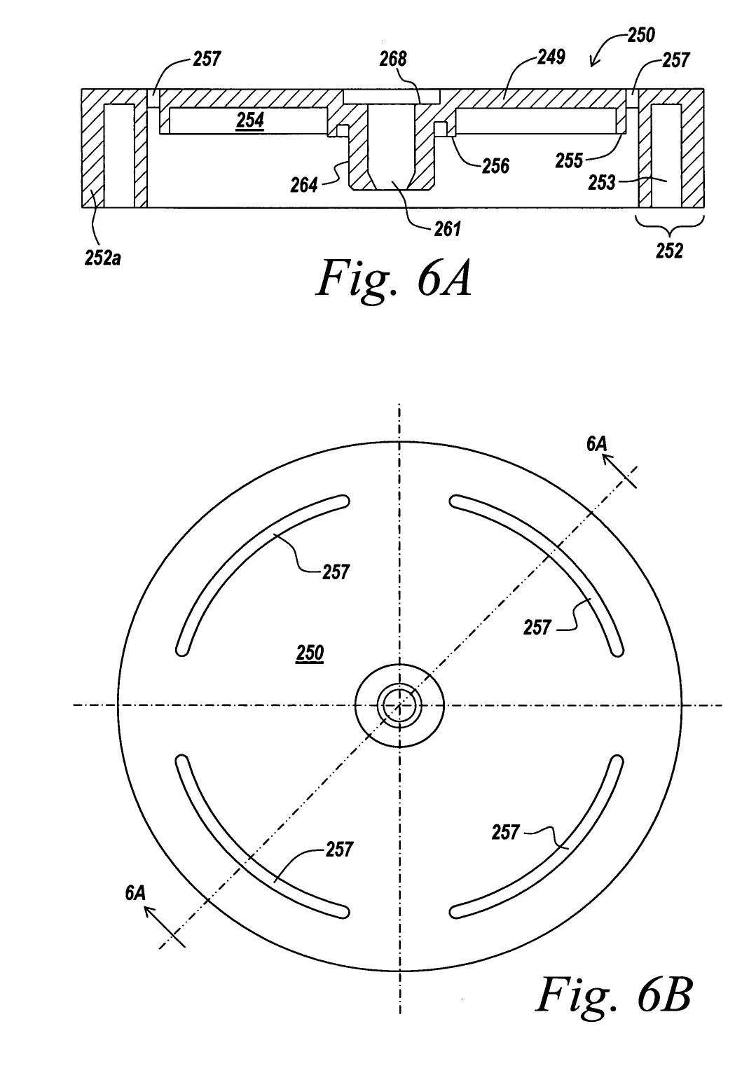

In the illustrative embodiment, the filtration seat 250, shown in FIGS. 5, 6A and 6B comprises a disc-like body 249 having a flange 252 for coupling the filtration seat to the filtration housing 240. The flange 252 may include an axially extending groove 253 formed in an upper surface thereof for receiving a protrusion 248 of the filtration assembly housing. Similarly, the filtration housing 240 may include an axially-extending groove 249 for receiving the outer portion 252a of the flange 252. In this manner, alignment and mating of the components is facilitated.

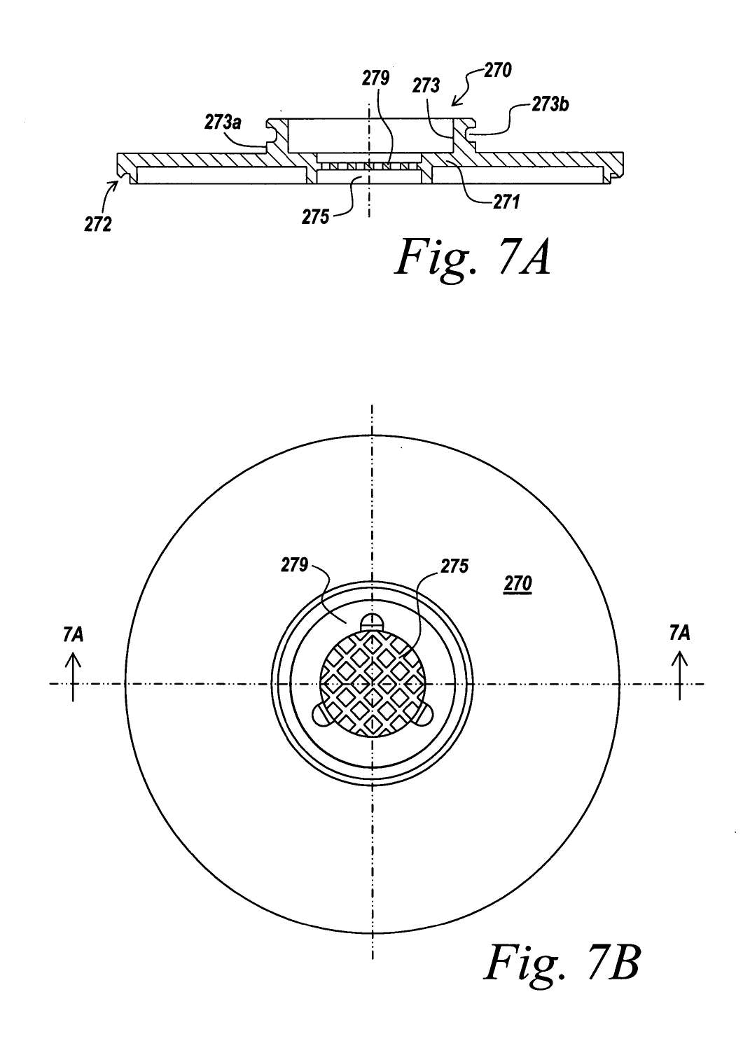

In the illustrative embodiment, the filtration capping element 270 is press-fit onto the filtration assembly housing to eliminate rough edges from the filtration chamber 251. For example, the filtration capping element 270, which comprises a flanged disc-like component, as shown in FIGS. 7A and 7B, may include an external ledge 272 configured to mate with an internal ledge 246 of the housing upper flange 245. Those skilled in the art will recognize that any suitable means for coupling the filtration capping element 270 to the filtration housing 240 may be used.

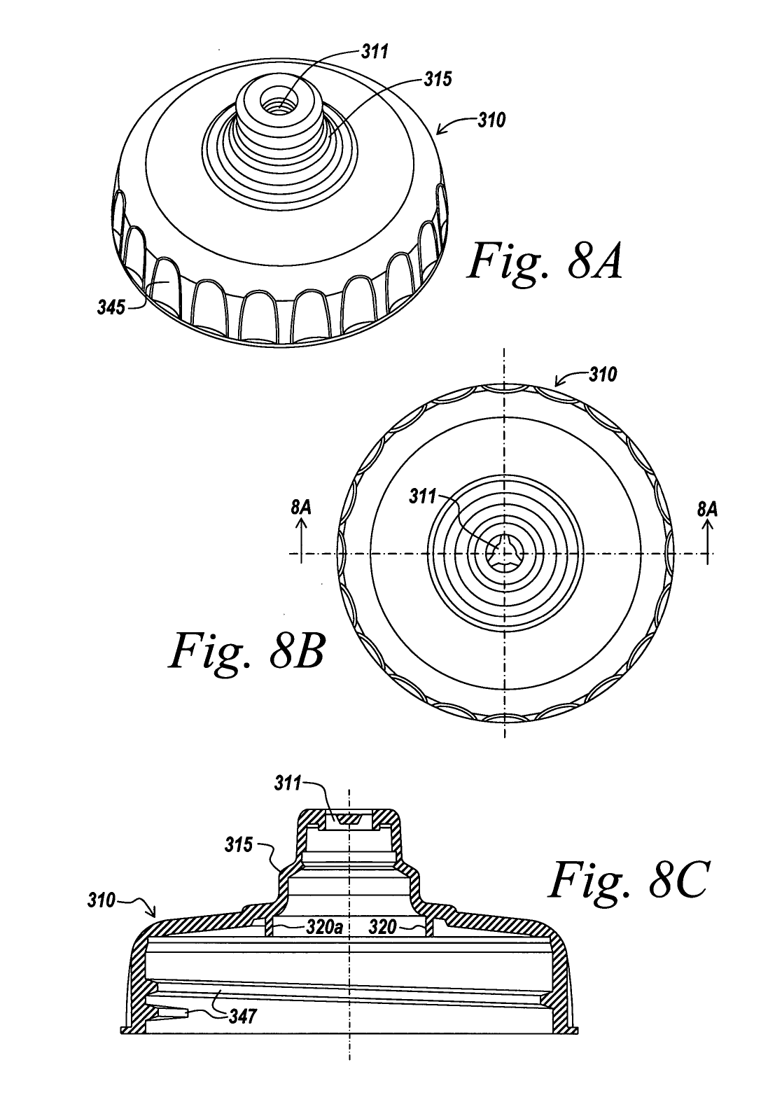

Referring again to FIGS. 3 and 4, as well as to FIGS. 8A, 8B and 8C, the dispenser capping element 310 caps the filtration assembly housing 240. The dispenser capping element 310 may form a drinking spout 311 for releasing filtered liquid from the system 100. As shown, the dispenser capping element 310 may include a lower tubular flange 345 configured to surround and engage the upper tubular flange 245 of the filtration assembly housing 240. The lower tubular flange 345 thus preferably has a slightly larger inner diameter than the outer diameter of the filtration assembly housing 240. Internal threads 347 on the lower tubular flange may engage external threads 247 on the upper tubular flange 245 to couple the dispenser capping element 310 to the filtration assembly 210. As shown, the bottom end 348 of the dispenser capping element flange 345 may abut a ledge 248 formed on an external surface of the filtration housing assembly 240 when the dispenser capping element is fully engaged. The dispenser capping element may be removable from the filtration assembly 210, for example, in order to replace a filtration element, or may be locked to the filtration assembly. The flange 345 may include texture on the external surface to facilitate gripping and twisting of the flange 345 to selectively remove the capping element 310.

As also shown in FIG. 3, and FIG. 8C, the dispenser capping element 310 may also include an internal annular projection 320 at the bottom of the neck 315 of the dispenser capping element 310. The internal projection 320 may be ring-shaped, comprise a plurality of individual projections spaced about a circumference or have another suitable configuration. The internal projection 320 is configured to abut a main body portion 271 of the filtration capping element 270 when the system 100 is assembled to ensure proper alignment of the components. As shown in FIG. 2, and FIG. 7a, the filtration capping element 270 further includes a central, upward extending flange 273 surrounding an opening 275 for allowing passage of a filtered liquid towards the neck 315 and drinking spout 311 of the dispenser capping element 310. A radially outer surface 273a of the central, upward extending flange 273 abuts a radially inner surface 320a of the internal projection to seal the filtration chamber 251. In the illustrative embodiment, the radially outer surface 273a includes a groove 273b for receiving a sealing element, illustrated as an O-ring 420, to provide enhanced sealing between the components 270, 310. The components 270, 310 may be press-fit together to couple the two components, though other coupling mechanisms are within the realm of the invention. Alternatively, a groove may be formed on the radially inner surface 320a for receiving a sealing element. One skilled in the art will recognize that the invention is not limited to the illustrative manner for sealing the filtration chamber 251 and that alternative configurations are within the scope of the invention.

Referring again to FIGS. 3, 5 and 6a, the filtration seat 250, which comprises a substantially disc-shaped body 249, may further include a ring-shaped depression 254 formed by a radially outer seating flange 255 and a radially inner seating flange 256. The ring-shaped depression 254 is configured to receive and seat a filtration element 280 for filtering a liquid. As shown, the filtration seat 250 further includes radial openings 257 for allowing communication with the interior of the dispenser body 110 when the filtration assembly 210 is coupled to the dispenser body. During a filtration process, liquid stored in the dispenser body 110 passes through the radial openings 257 and into the filtration chamber 251. The liquid then passes through the filtration element 280, which removes impurities, contaminants, chemicals, viruses and/or other unwanted components from the liquid before passing the thus-filtered liquid through the opening 275 of the filtration capping element 270 to the drinking spout 311.

The illustrative system 100 may further include a spacer, illustrated as an o-ring seal 430, at the interface between the dispenser body 110 and the filtration seat 250 to seal the system, in particular the filtration chamber 251, prevent leaks and ensure that the liquid flows into the filtration chamber 251 for filtering.

As shown in FIG. 7B, the opening 275 of the filtration capping element 270 may include webbing 279, mesh or other configuration to prevent large objects from backtracking into the filtration chamber 251 while allowing expulsion of the filtered liquid from the filtration chamber 251.

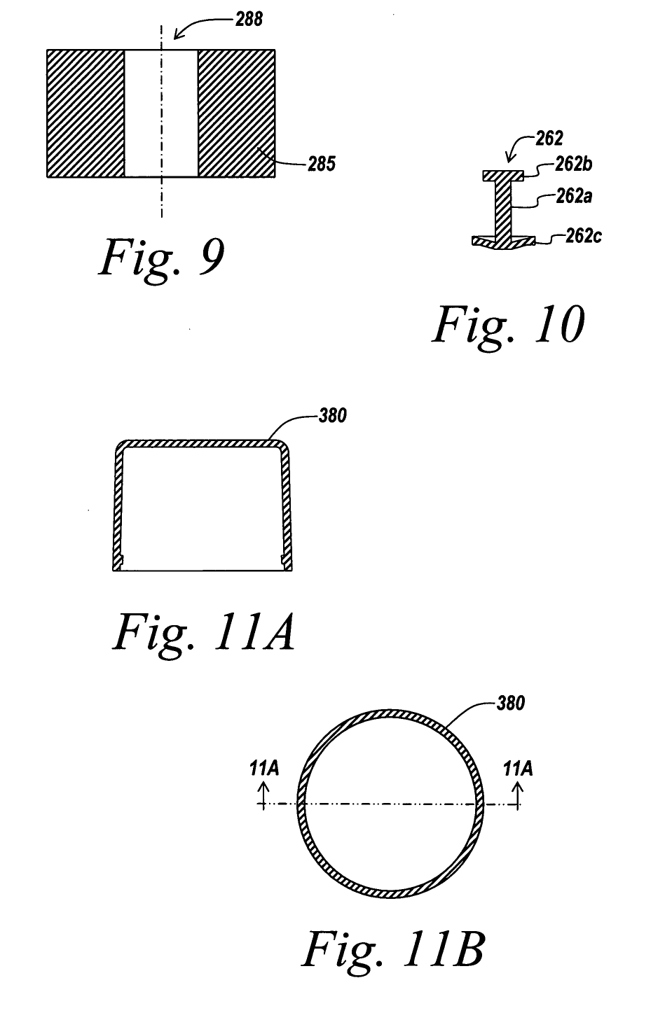

The filtration element 280, an embodiment of which is shown in FIG. 9 may comprise any suitable means for filtering a liquid. The illustrative filtration element is annular, though the invention is not limited to the illustrative shape. The filtration element is formed of a filter media 285 selected to provide a desired degree and quality of filtering. In one embodiment, the filtration element 280 comprises a hollow fiber filter that can remove particles as small as 0.05-0.02 microns. In another embodiment, the filtration element 250 comprises a carbon filter that can remove particles as small as 3 microns. One skilled in the art will recognize that any suitable material or element for performing filtration of a liquid may be used, including, but not limited to, ceramic, sediment and other filtration means known in the art. The filter media may also comprise a mixture or combination of different types of materials.

For example, the filtration element 280 may comprise a hollow fiber bundle (membrane) inserted into the filtration assembly 210 during assembly. Hollow fibers may be well suited to withstand exposure to various chemicals and viruses, and may be effective under low pressure and a low flow rate of liquid. The hollow fiber filter can filter particles having areas as small as between about 0.05 microns and about 0.02 microns. During filtration, the liquid passes through the hollow fiber membrane and eliminates the contaminant and viruses. The membrane pore size distribution may be controlled by having good base membrane chemistry and a tightly controlled manufacturing process. The hollow fiber membrane is capable of having a structure, function and operation to perform virus rejection.

Alternatively, the filter element 280 may comprise a carbon block. For example, a special activated carbon with exclusive media may be used to filter the liquid. Such a carbon block is inert against attacks by various chemicals. In another embodiment, the carbon block may be dry sintered using polyethylene as a bonding material. Good filtration efficiency is obtained by choosing an appropriate thickness of the exclusive carbon block. An activated carbon block is also effective under low pressure and low flow rate of liquid. With the pressure and quantity of liquid involved in many embodiments of the illustrative dispenser, the carbon block filters particles as small as 3 microns. The liquid passes through the carbon block via a tortuous path as the liquid is simultaneously cleaned and purified.

As shown, a lower filter seal 284 may seal the filtration element 280 against the filtration seat 250. An upper filter seal 286 may seal the filtration element 280 against the filtration capping element 270. The filter seals 284, 286 may comprise any suitable sealing element, such as food grade glue, ultra sonic welding, elastomeric gaskets and so on.

Referring again to FIGS. 3, 5, 6A and 6B, the filtration seat may further include an air vent assembly 290 to allow pressure within the system 100 to equilibrate after liquid is squeezed out of the dispenser, permitting a user to squeeze again shortly thereafter. As shown, a central, upward extending protrusion 264 extends from the filtration seat base 249. The protrusion 264 includes an axially extending opening forming an air vent 261. On a bottom surface of the filtration seat 250, the air vent forms a recessed seat 263. As shown in FIG. 10, the valve 262 for the air vent assembly 290 includes a stem 262a, an anchor 262b extending from the protrusion 260 and larger than the air vent 261, and an umbrella portion 262c seated in the recessed seat 263 forming a check valve.

When squeezing the dispenser body, the air valve 290 allows the contaminant liquid to pass through the filter assembly 210. In operation, a user squeezes the dispenser body 110, thereby creating enough pressure within to force liquid from outside the filtration assembly through the radial openings 257 of the filtration seat 250 and through the filter element 280, which filters the liquid. Then, the liquid flows through the top of the dispenser capping element 310.

After squeezing the dispenser to force the liquid to go through the filter element, the air sucks through the filtration capping element 310 and returns to its regular shape for a second squeeze. As the user releases the pressure on the dispenser body 110, the dispenser begins to assume its original shape. This creates a negative pressure in the dispenser body interior, and atmosphere air is forced into the dispenser through the valve 290, replacing the volume of the water dispensed. The air passes through a path of least resistance to return the system 100 to a state where it is ready for the next squeeze in an appropriate amount of time. In particular, the air that passes through the air vent assembly 290 acts as an effective one way valve, which allows air to go inside the dispenser body, but doesn't allow liquid to escape the dispenser through the vent hole. Thus, all liquid leaving the dispenser body storage area 110 is filtered.

FIG. 11 illustrates a dust cap 380, which may cover the dispenser capping element to prevent contamination, accidental spills, and so on. The dust cap 380 snap-fit onto the dispensing capping element 310, or coupled through any suitable means. Alternatively, the system 100 may omit the dust cap.

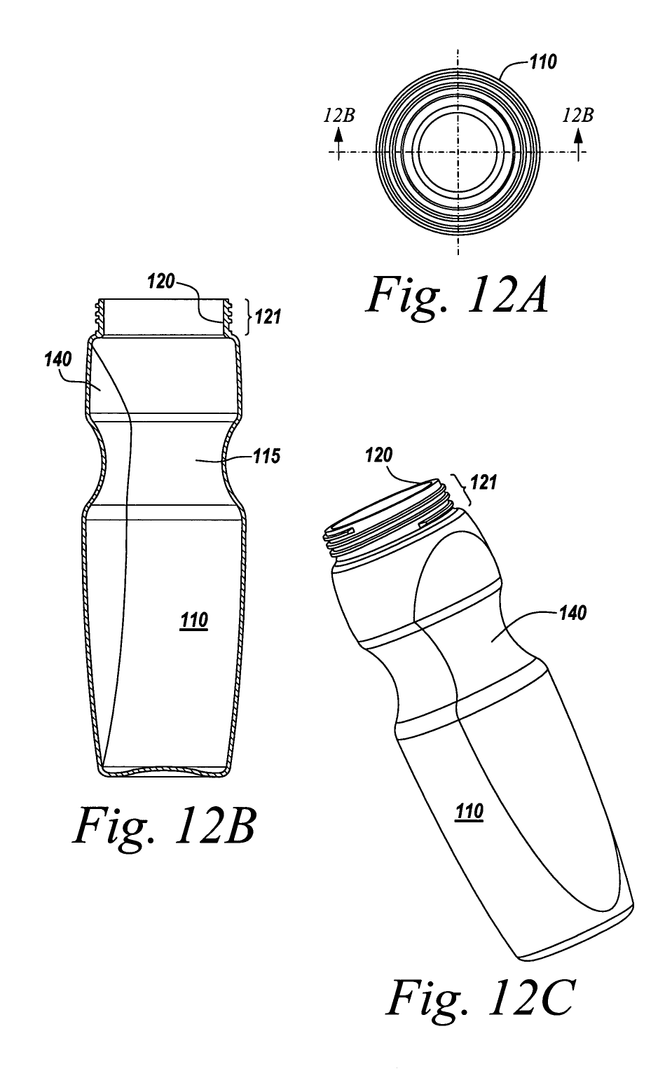

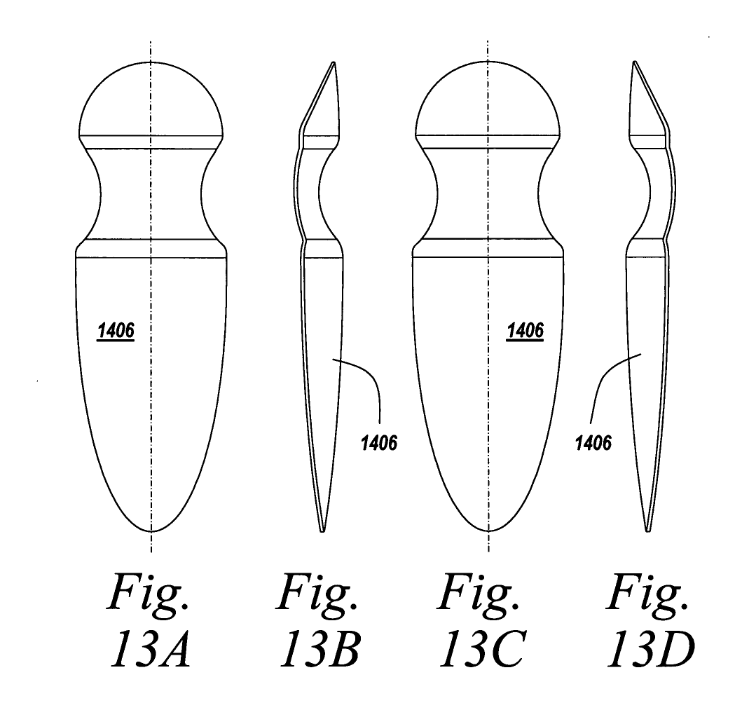

FIGS. 12a-c illustrate the configuration of the dispenser body according to one embodiment of the invention. As shown, a material 140, such as rubber or other suitable material, may be coated on an external surface of the dispenser body 110 to facilitate gripping of the system. The rubber coating 140 may comprise two separate elements 140a and 140b, shown in FIGS. 13a-d, attached to the sides of the dispenser body 110. Alternatively, the rubber may form at least a portion of the side wall of the dispenser body 110.

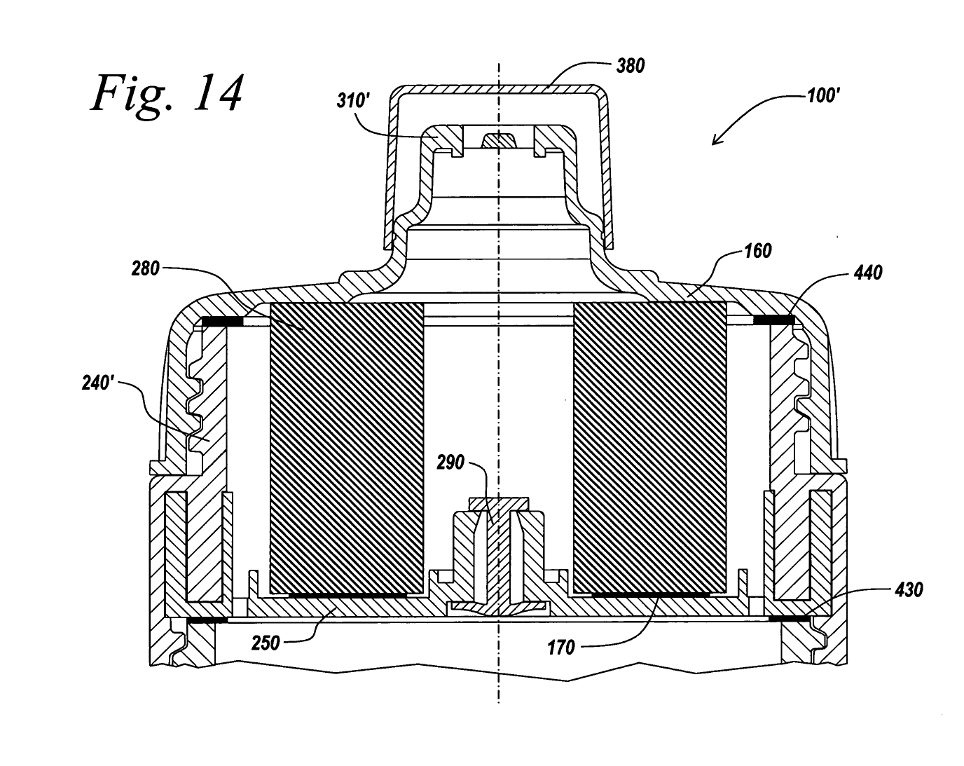

FIG. 14 illustrates a liquid filtration and dispensing system 100′ according to another embodiment of the invention. Components identical to the liquid filtration and dispensing system described with respect to FIGS. 1-13d are identified with the same reference number. Components that have been modified are identified by the same reference number with a prime (i.e., 310′). The embodiment of FIG. 14 omits the filtration capping element 270, and instead couples the filter element 280 directly to the dispenser capping element 310′, which omits the protrusion 320 on the inner surface thereof. The system of FIG. 14 further includes an additional seal, illustrated as a rubber washer 440 or o-ring, between the filtration assembly housing 240′ and the dispenser capping element 310′. In the embodiment of FIG. 14, the filtration housing assembly 240′ further omits the internal ledge 246 for interfacing with the omitted filtration capping element.

Seals 160 and 170 seal the upper and lower surfaces, respectively, of the filtration element 280. The upper seal 160 may seal the filtration element 280 against an interior surface of the dispenser capping element 310′, while lower seal 170 seals the filtration element 280 against the filtration seat 250. The seals 160 and 170 may be formed from hot glue, an adhesive, rubber, or other suitable sealing material.

The seals protect against any accidental leakage or any bypass of contaminant liquid through the filter assembly 210′.

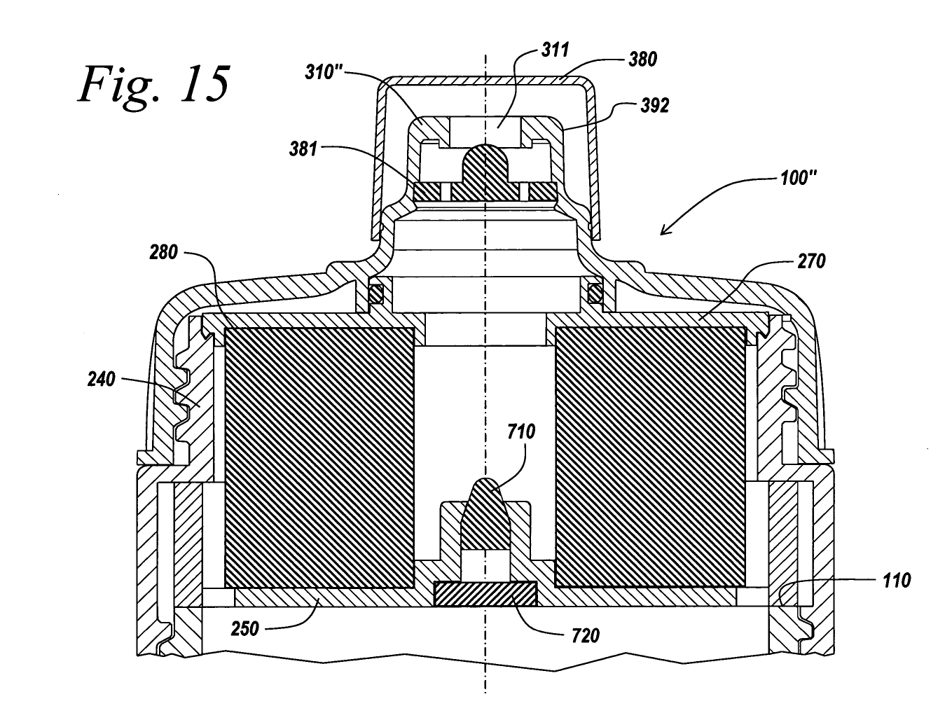

FIG. 15 is a detailed view of a filtration assembly region of a liquid filtration and dispensing system 100″ according to another embodiment of the invention. Components identical to the liquid filtration and dispensing system described with respect to FIGS. 1-13d are identified with the same reference number. Components that have been modified are identified by the same reference number with a double prime (i.e., 310″).

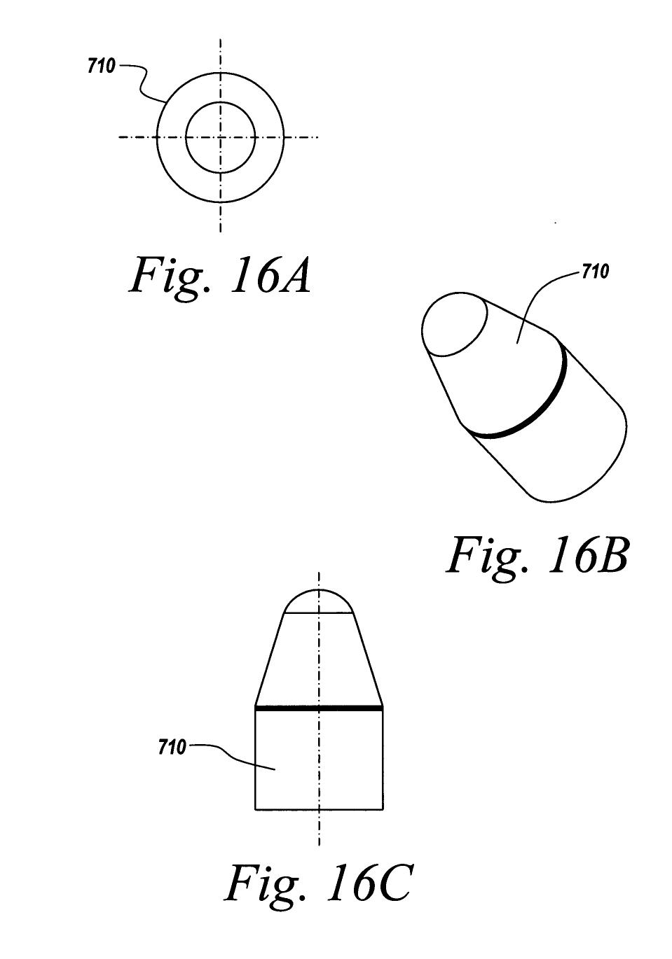

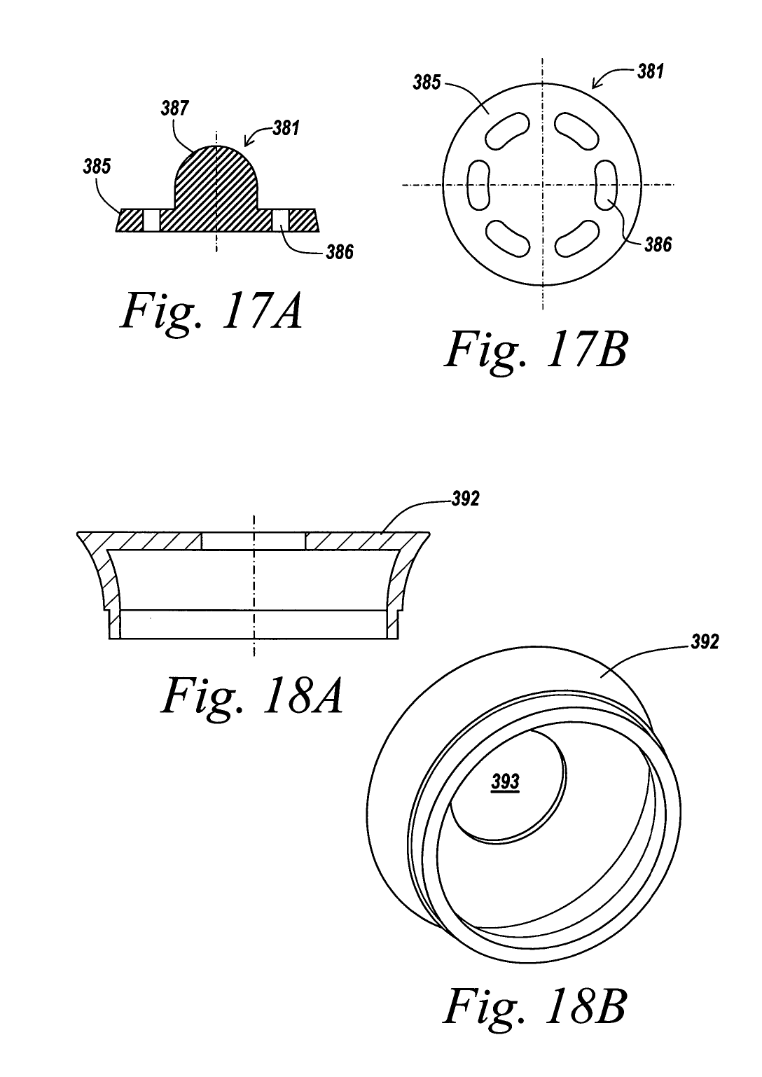

The system 100″ of FIG. 15 includes a seal valve 710, shown in detail in FIGS. 16A-C, extending from the protrusion 260 of the filtration seat 250, and an air filter 720 in the recessed seat 263″ of the filtration seat 250″ to provide venting of the dispenser body 110. The illustrative seal valve 710 is substantially cone-shaped, though the invention is not limited to this embodiment.

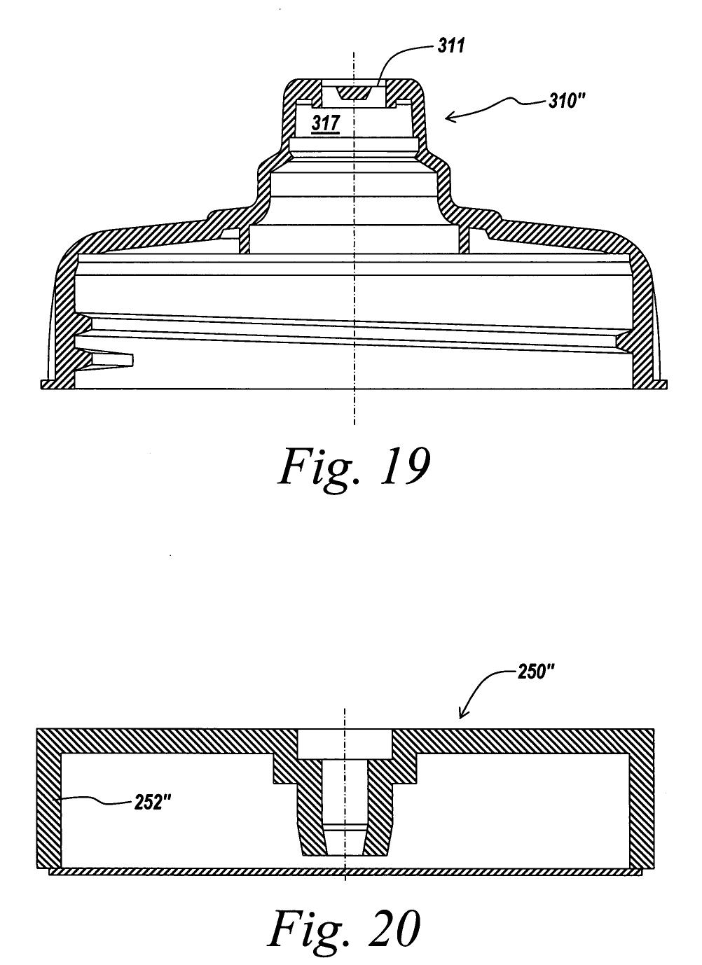

A top holder 381, shown in detail in FIGS. 17A-C, and an elastic rubber 392, shown in detail in FIGS. 18A-18B are seated in the upper interior region 317 of the neck of the dispenser capping element 310″, shown in FIG. 19 to facilitate a one-way flow of liquid from the system and prevent contamination. The illustrative top holder 381 has a disc-shaped base 385, a plurality of radial opening 386 for allowing the passage of filtered liquid therethrough, and a substantially bulbous projection 387. When assembled, the bulbous projection 387 extends through an opening 393 of the elastic rubber 392, which is formed of any suitable flexible material. During dispensing, liquid flows through the openings 386, around the projection 387 and through the opening 393 to reach the dispensing opening 311.

In an alternative embodiment, shown in FIG. 20, the filtration seat 250″ may include a single outer flange 252″ with no annular recess 253.

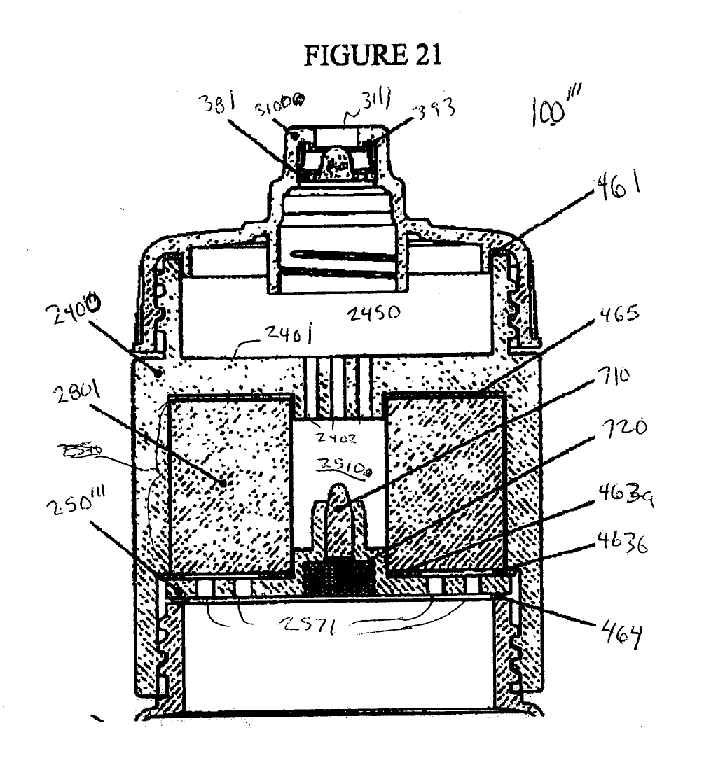

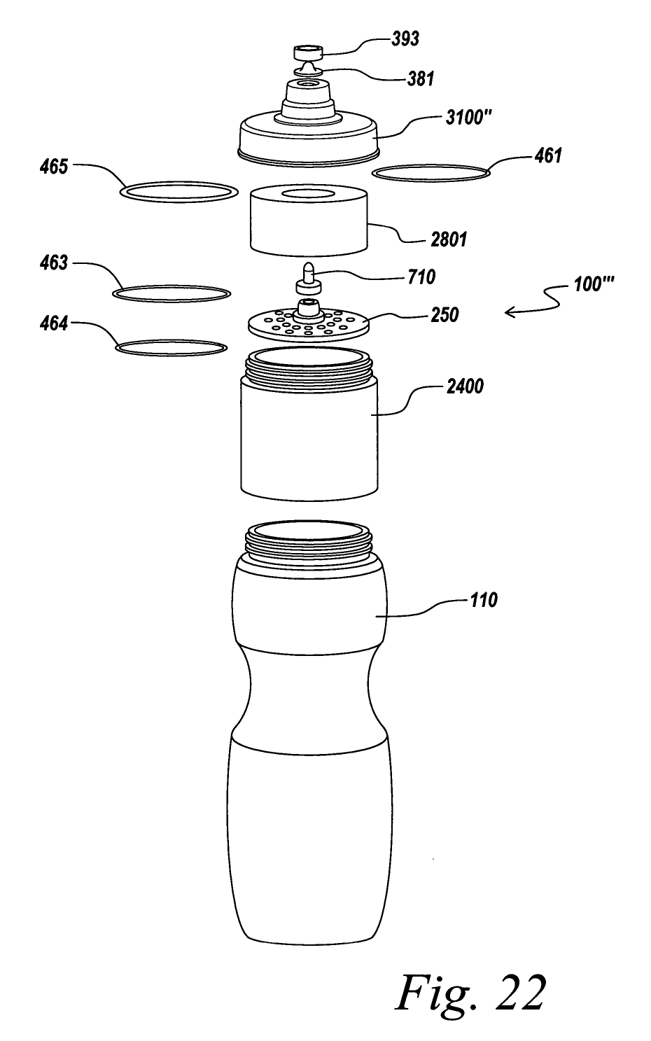

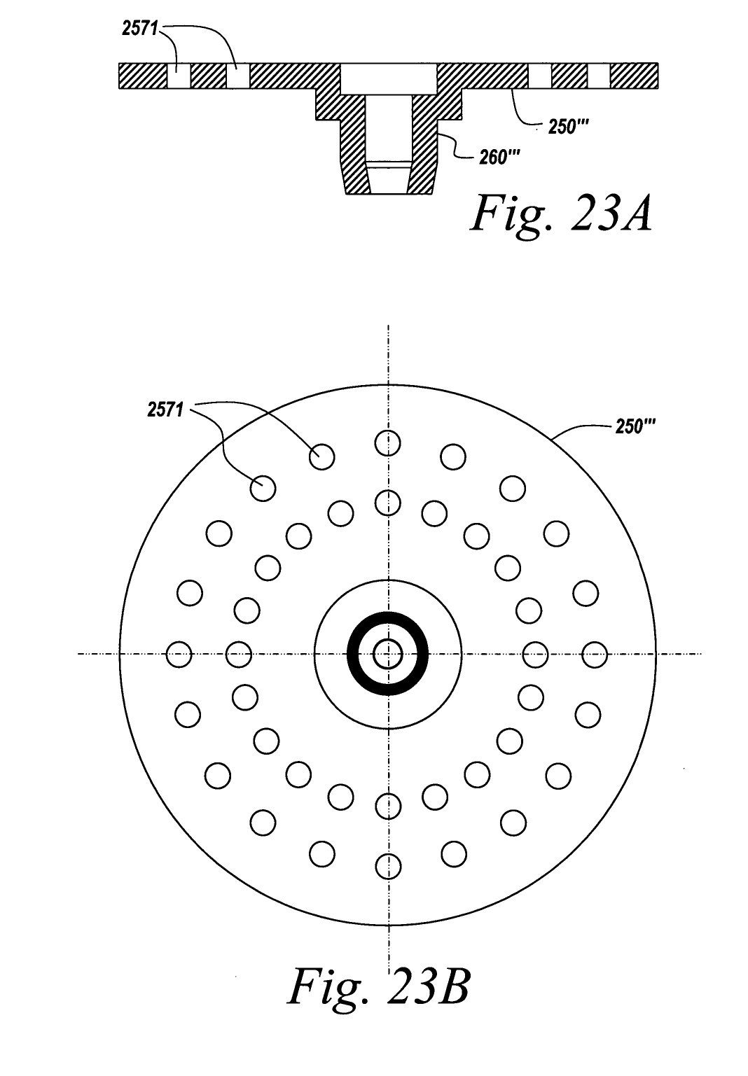

FIG. 21 illustrates a liquid filtration and dispensing system 100′″ of still another embodiment of the invention. FIG. 22 is an exploded view of the system 100′″ of FIG. 21. In the embodiment of FIG. 21, the filtration seat 250′″, shown in detail in FIGS. 23a and 23b, may omit a flange and comprise a disc-shaped body with a central protrusion 260′″ forming the air valve. In the embodiment of FIGS. 22A and 22B, the filtration seat 250″ further includes two rings of openings 2571 for passing liquid from the dispenser body into the filter. The liquid passes through the openings 2571 into the bottom surface of the filtration device 2801. The openings 2571 may have any suitable configuration, size and arrangement.

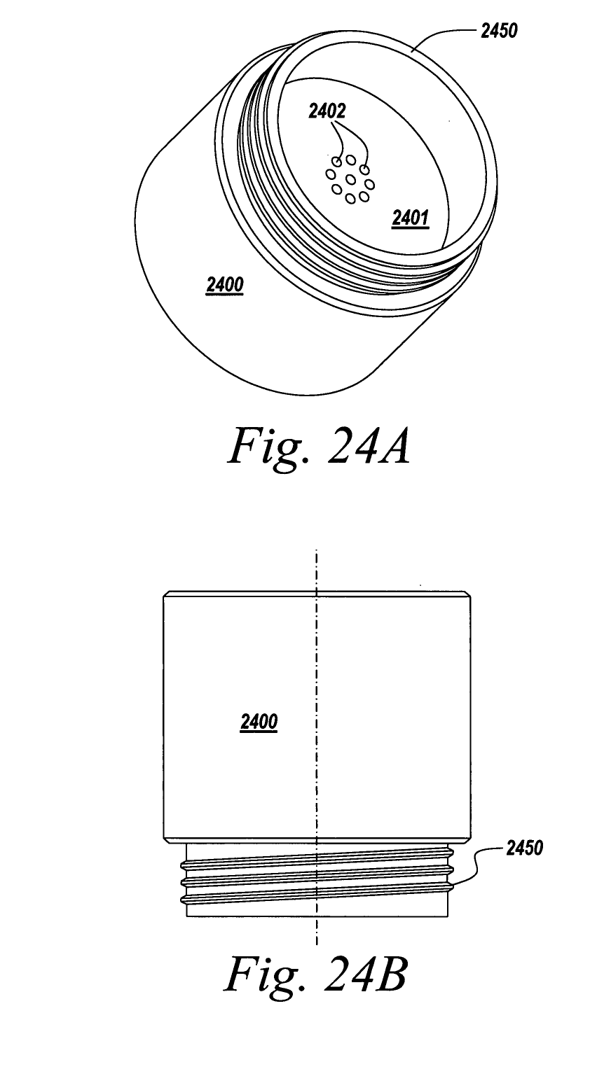

In addition, in the embodiment of FIGS. 21 and 22, the filtration assembly housing 2400, shown in detail in FIGS. 24a and 24b, comprises a tubular housing including an externally threaded upper end for engaging a capping element 3100 and an internally threaded lower end 2450 for engaging the dispenser body, as described above. The filtration seat 250′″ is held by friction fit between the dispenser body 110 and the filtration assembly housing 2400, as shown in FIG. 21. The illustrative filtration assembly housing 2400 further includes a transverse component 2401 defining a ceiling of the filtration chamber 2510. The transverse component 2401 includes openings 2402 for allowing the passage of filtered liquid after the liquid passes from the dispenser body, through the openings 2571, through the filter element 2801 and into a receiving chamber 2450. The filtered liquid then passes through the dispenser capping element 3100 and through the drinking spout 3111.

Seals 461, 465, 464 and 463, which may be O-rings or other types of rubber gaskets, seal between different components to ensure that leakage and/or contamination does not occur. The seals 465 and 463, which seal the upper and lower surfaces of the filter element 2801 in the filtration chamber 2510 may comprise an adhesive that also bonds the filter element 2801 to the filtration housing 2400 and filtration seat 250′″, respectively. The seal 463 may comprise an inner seal 463a and an outer seal 463b. Any suitable means may be used to provide sealing between different components of the filtration and dispensing system, and the invention is not limited to the illustrative embodiments.

The present invention provides significant advantages over prior beverage dispensers. For example, the use of a hollow fiber filter element mechanically strains out dirt, sediments, rust, algae, cryptosporidium, asbestos, pathogen, virus and particulate matters. This is all accomplished by water pressure so electricity is not required. A carbon block filer element mechanically strains out dirt, sediments, odor, reduce chlorine, rust, algae, cryptosporidium, asbestos, and particulate matters. This is all accomplished by water pressure so electricity is not required. Such a filter even works on a small squeeze in an emergency. The filtration assembly housing is designed to use any filter media available, such as hollow fiber membrane, sediment filter, ceramic filer and more. Moreover, activated carbon bonds to thousands of chemicals known to man. When water or another liquid is forced through the solid carbon block, it is forced to slow down and increases the contact time with the carbon, allowing the carbon bonding to take place which reduces certain chemicals pollutants like toxics, pesticide, THM's, chlorine, bad taste and odors.

The system for storing, carrying, filtering and dispensing a filtered liquid is also inexpensive. The filter element and/or the filtration assembly is replaceable, can last for more than 100 gallons of liquid depending upon the amount of sediments and dirt. The filtration assemblies 210 are designed to be replaced in a minutes. Thus, the dispenser body 110 and/or capping element 310 may be re-used over and over again, with a replaceable filtration mechanism.

The invention also improves health. Trace minerals, such as dissolved calcium and magnesium, do not bond to hollow fiber membrane and are allowed to pass through, thereby retaining the health quality and good taste of water and other liquids. Most bacteria are strained out and remain on the outside of the hollow fiber. Heavy metals like lead are absorbed (or collected) by the carbon.

The invention further promotes convenience. The type of filter system provides healthier filtered water on demand so there is no storage, it doesn't run out at inconvenient times, no ordering bottles or picking bottles up from the store.

The present invention has been described relative to an illustrative embodiment. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

What is claimed is:

1. A dispenser for dispensing a liquid, comprising:
a dispenser body including a liquid chamber for storing a liquid;
a filtration assembly removably connected to the dispenser body for receiving a filter element for filtering said liquid, the filtration assembly including an opening for releasing filtered liquid from the dispenser.

2. The dispenser of claim 1, wherein the filtration assembly includes a substantially tubular filtration assembly housing and a filtration seat seating the filter element thereon coupled to the filtration assembly housing.

3. The dispenser of claim 2, wherein the filtration assembly housing is press-fit into the filtration seat to form a filtering chamber for housing the filter element and performing a filtering process.

4. The dispenser of claim 3, further comprising a coupling mechanism formed on a lower end the filtration assembly housing to be coupled to the dispenser body.

5. The dispenser of claim 4, wherein the coupling mechanism comprises threading formed on an internal surface of the lower end of the filtration assembly body.

6. The dispenser of claim 5, further comprising a threading formed on an external upper surface of the dispenser body for coupling the dispenser body to the filtration assembly.

7. The dispenser of claim 3, further comprising a dispenser capping element including the opening formed therein coupled to the filtration assembly housing for covering the filtering chamber.

8. The dispenser of claim 3, wherein the dispenser capping element includes threads formed on a surface thereof for mating with threads formed on an upper end of the filtration assembly housing.

9. The dispenser of claim 7, further comprising at least one seal for sealing the filtering chamber.

10. The dispenser of claim 2, wherein the filtration seat comprises an air vent assembly formed therein for allowing air to flow into and out of the liquid chamber in the dispenser body.

11. The dispenser of claim 1, further comprising a filter element mounted in the filtration assembly, the filter comprising a filtering media for filtering a liquid passing from the liquid chamber to the opening in the filtration assembly.

12. The dispenser of claim 11, wherein the filter element includes a carbon filter for removing particles from a liquid that passes therethrough.

13. The dispenser of claim 12, wherein the carbon filter includes a tortuous path for passing the liquid through the filter element.

14. The dispenser of claim 11, wherein the filter element includes a hollow fiber filter for removing particles from a liquid that passes therethrough.

15. The dispenser of claim 11, wherein the filtration element is sealed in the filtration assembly.

16. The dispenser of claim 2, further comprising a filtration capping element coupled on a first side to an upper end of the filtration housing and defining a ceiling of the filtration chamber, the filtration capping element including a central opening to allow the passage of filtered liquid therethrough.

17. The dispenser of claim 16, further comprising a dispenser capping element including internal threads for mating with external threads formed on the upper end of the filtration housing, wherein the dispenser capping element is press-fit onto a second side of the filtration capping element.

18. The dispenser of claim 1, further comprising a dust cap for capping the opening in the filter cap assembly.

19. A filtration assembly configured to cap a liquid dispenser body, comprising:
a substantially tubular filtration housing;
a flanged, disc-shaped filtration seat disposed within and coupled to the filtration housing to form a filter chamber for receiving a filter element therein, the filtration seat defining a seat for seating the filter element; and
a top cap coupled to the filtration housing for covering the filtering chamber, the top cap including an opening formed therein for releasing a filtered liquid from the filter chamber,
wherein the filtration housing includes a coupling mechanism for coupling the filtration assembly to a liquid dispenser body.

20. The filtration assembly of claim 19, wherein the coupling mechanism comprises threads formed on an internal lower surface of the filtration housing for mating with corresponding threads on a liquid dispenser body.

21. The filtration assembly of claim 19, wherein the filtration seat includes a valved opening for allowing the passage of air, and filtration openings for allowing the passage of liquid from a dispenser body to the filtration chamber.

21. The filter cap assembly of claim 19, further comprising a filter element mounted in the filtration chamber, the filter element comprising a filter media for filtering a liquid passing from the liquid dispenser body to the opening in the filtration assembly.

22. A filter cartridge for a liquid dispenser, comprising:
a filtration housing;
a filter disposed in the filtration housing for filtering liquid passing through the liquid dispenser through the filtration housing; and
a coupling mechanism for releasably coupling the filter cartridge to the liquid dispenser.

23. The filter cartridge of claim 22, wherein the filter comprises a filtering media comprising at least one of carbon, activated carbon, hollow fibers, ceramic, sediment and combinations thereof.
